(19) United States
(12) Patent Application Publication
(10) Pub. No.: US 2009/0222253 A1
(43) Pub. Date: Sep. 3, 2009

(54) System and Method for Switch-Level Linear Simulation Using Verilog

(76) Inventor: Thomas Jay Sheffler, San Francisco, CA (US)

Correspondence Address: MORGAN LEWIS & BOCKIUS LLP/RAMBUS INC., 2 PALO ALTO SQUARE, 3000 EL CAMINO REAL, PALO ALTO, CA, 94306, US

(21) Appl. No.: 12/390,382

(22) Filed: Feb. 20, 2009

Related U.S. Application Data
(60) Provisional application No. 61/033,372, filed on Mar. 3, 2008.

(51) Int. Cl. G06F 17/50; G06F 9/46

(52) U.S. Cl. 703/16; 718/102

(57) ABSTRACT

A method for rapidly simulating combined analog circuits and digital circuits includes separating the combined circuits into a linear sub-network and logic sub-network. Shared nodes, shared by the linear sub-network and logic sub-network, are identified. The values of the shared nodes represent logic state values, or digital values, in the logic sub-network, and represent voltages, currents, control inputs and/or circuit parameters in the linear sub-network. Operation of the logic sub-network is simulated using logic node values for the shared nodes. Operation of the linear sub-network is simulated using linear node values for the shared nodes. The method allows fast simulation and rapid revision of mixed signal designs, saving design time and computing resources.

### RELATED APPLICATION

This application claims priority to U.S. Provisional Application No. 61/033,372, filed Mar. 3, 2008, entitled “System and Method for Switch-Level Linear Simulation Using Verilog,” which is incorporated herein by reference in its entirety.

### TECHNICAL FIELD

The disclosed embodiments relate generally to electronic design automation (EDA) verification tools. More particularly, the disclosed embodiments relate to methods, systems, and user interfaces for performing switch-level linear modeling using the Verilog hardware description language.

### BACKGROUND

FIG. 1 shows a simplified representation of a design flow 100 for the design, verification and manufacture of integrated circuits (chips). Many of the operations in the design flow 100 are performed using computer-implemented tools, including computer-aided design (CAD) tools, now more commonly referred to as electronic design automation (EDA) tools. Many of the operations are implemented in software running on hardware servers and workstations.

In a design specification document 110, parameters for a chip design or semiconductor product are listed, and characteristics such as function, speed, power consumption, noise levels, signal quality, cost, etc. are described.

In a circuit implementation operation 120 a semiconductor circuit is generated (i.e., one or more circuit designs for the circuit are generated) based on the information in specification document 110. For ease of explanation and discussion, in the following discussion the terms “circuit” and “semiconductor circuit” shall be understood to mean the design (e.g., netlist and/or physical layout) of the circuit, as opposed to a physical circuit that physically conducts currents and signals. EDA tools are commonly used to generate the detailed design of a semiconductor circuit. In a system specification operation 122, the design parameters 110 for the semiconductor circuit, including an interface to a system, are provided to one or more EDA tools. The design parameters are later checked against a completed semiconductor circuit. In a circuit design and test operation 124, a circuit implementing the system specification 122 is generated manually (known as a “custom” or “full custom” design), or automatically by a compiler tool, using ready-made IP functions, etc., or by using a combination of these operations. In a custom design, the circuit is entered by schematic capture, by a hardware description language (such as Verilog, VHDL, or any other hardware description language (HDL)), by graphic entry, or by other means. In a circuit synthesis operation 126, a netlist of the circuit is generated by synthesizing the circuit design 124 into a gate-level representation of the circuit design. Synthesis is generally performed only on synthesizable logic sections of the circuit 124. If the circuit 124 includes a section that cannot be synthesized (e.g., an analog block), that section is called a non-synthesizable section. In a verification operation 128, the netlist output by the circuit synthesis operation 126 is verified for functionality against the circuit design 124, and optionally against the desired system specification 122, using a test-bench program or test vectors. The operations 124, 126, and 128 are repeated until the netlist meets the desired parameters. Improvements to the verification operation 128, which may be used (for example) when an earlier version of the circuit design has already been verified, are discussed in more detail below.

In a floor planning and layout operation 130, a physical implementation of the netlist on a physical medium, such as a die on a semiconductor wafer, is specified. In an analysis operation 132, a transistor-level simulation of the netlist from circuit synthesis operation 126 is performed to verify functionality, timing, and performance across predefined or user-specified ranges of process, voltage, and temperature parameters. In a physical verification operation 134, the physical implementation 130 is analyzed for parasitic effects such as parasitic capacitance, inductance, resistance, and other effects. The physical implementation is verified to make sure it does not violate design rules for the semiconductor process on which the integrated circuit will be manufactured. Operations 130, 132, and 134 are repeated until the physical implementation (i.e., a specification of the physical implementation) meets desired parameters. In a mask preparation operation 136, optical pattern data (commonly called “mask data”) is generated from the physical implementation for use on a photolithographic mask.

In a tape-out operation 140, the optical pattern data 136 is written to a magnetic tape (this process is called “tape out”) and/or sent to a semiconductor wafer manufacturer by physical or electronic means. In an operation 150, the semiconductor wafer manufacturer uses the optical pattern data 136 to generate photolithographic masks. These photolithographic masks are then used by a wafer fabricator to manufacture semiconductor wafers. In saw operation 160, the manufactured semiconductors wafers are sawn into individual dice, in a die separation process. The individual dice are then assembled into individual packages and tested. Optionally, preliminary testing of the individual die may be performed before the wafers are sawn into individual dice, thereby identifying die which may be discarded prior to additional investment of testing and assembly resources. In operation 170, the packaged integrated circuits are prepared for sale.

### BRIEF DESCRIPTION OF THE DRAWINGS

Various embodiments are disclosed in the following Description of Embodiments herein in conjunction with the following drawings in which like reference numerals refer to corresponding parts throughout the figures.

FIG. 1 is a block diagram illustrating an exemplary design flow for the design, verification and manufacture of integrated circuits.

FIG. 2A is a block diagram illustrating nodes shared between a logic sub-network and a linear sub-network, in accordance with some embodiments.

FIG. 2B is a block diagram illustrating passing values through a shared node from a logic network to a linear network, in accordance with some embodiments.

FIG. 2C is a block diagram illustrating passing values and currents through a shared node from a linear network to a logic network, in accordance with some embodiments.

FIG. 2D is a block diagram illustrating passing values through a shared node from a logic network to a linear control input in accordance with some embodiments.

FIG. 2E is a block diagram illustrating passing values through a shared node from a logic network to a linear control input in accordance with some embodiments.

FIG. 3 is a block diagram illustrating a logic sub-network having an embedded linear sub-network with shared nodes for passing values into and out of the linear sub-network, in accordance with some embodiments.

FIG. 4 is a block diagram illustrating a linear circuit driven by and monitored by Verilog code in accordance with some embodiments.

FIG. 5 is a diagram of a Verilog model of a linear current source in accordance with some embodiments.

FIG. 6 is a diagram of a Verilog model of a linear resistor in accordance with some embodiments.

FIG. 7 is a diagram of a Verilog model of a linear voltage source in accordance with some embodiments.

FIG. 8 is a diagram of a Verilog model of a linear voltage probe in accordance with some embodiments.

FIG. 9 is a diagram of a Verilog model of a switch in accordance with some embodiments.

FIG. 10 is a diagram of a Verilog model of an ideal operational amplifier in accordance with some embodiments.

FIG. 11 is a diagram of a Verilog model of an operational amplifier having an adjustable gain in accordance with some embodiments.

FIG. 12 is a diagram of a Verilog model of a linear voltage controlled voltage source in accordance with some embodiments.

FIG. 13 is a diagram of a Verilog model of a linear voltage controlled current source in accordance with some embodiments.

FIG. 14 is a diagram of a Verilog model of a linear current controlled voltage source in accordance with some embodiments.

FIG. 15 is a diagram of a Verilog model of a linear current controlled current source in accordance with some embodiments.

FIG. 16 is a diagram of a linear circuit and its linear matrix representation in accordance with some embodiments.

FIG. 17 is a diagram of Verilog code to map linear values to and from wires in accordance with some embodiments.

FIG. 18 is a diagram of composite analog components formed from linear circuits in accordance with some embodiments.

FIG. 19 is a flowchart of a method of simulating a circuit including a linear sub-network and a logic sub-network that share a node in accordance with some embodiments.

FIG. 20 is a flowchart of a method of simulating a circuit including performing conversions between an analog domain and a digital domain in accordance with some embodiments.

FIG. 21 is a flowchart of a method of simulating a circuit including a linear sub-network and a logic sub-network that share a node in accordance with some embodiments.

FIG. 22 is a flowchart of a method of simulating a circuit including a linear portion and a digital portion that share a node in accordance with some embodiments.

FIG. 23 is a verification system for simulating a circuit in accordance with some embodiments.

FIG. 24 is a verification system for simulating a circuit in accordance with some embodiments.

FIG. 25 is an exemplary code listing for Verilog circuit elements.

FIG. 26 is an exemplary code listing for Verilog circuit elements.

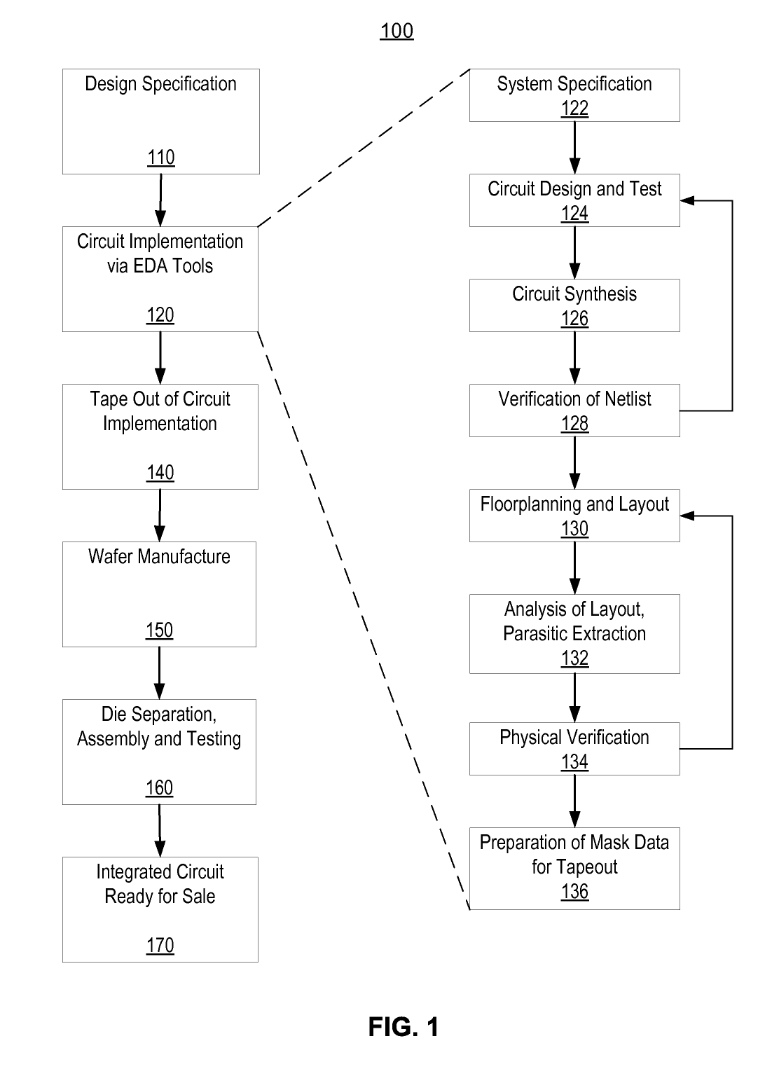

### DESCRIPTION OF EMBODIMENTS

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding. However, it will be apparent to one of ordinary skill in the art that embodiments can be practiced without these particular details. In other instances, methods, procedures, components, and networks that are well known to those of ordinary skill in the art are not described in detail to avoid obscuring the explanation.

The remainder of the description begins with an overview of several embodiments followed by the more detailed discussion of those embodiments with references to the figures.

In the design of semiconductor circuits, it is beneficial to simulate a circuit design to verify its behavior before manufacturing (fabricating) the circuit. Simulation involves calculating the behavior of a circuit, typically using one or more computer-implemented circuit simulation tools. By simulating the circuit, problems can be found and corrected before incurring the expense and delay of manufacturing the circuit.

In one embodiment, a computer-implemented method of simulating a circuit includes receiving a representation of an electrical network having a plurality of sub-networks. The plurality of sub-networks include a logic sub-network and a linear sub-network that share a node. The method also includes generating a linear matrix for the linear sub-network, and performing an event-based simulation of the linear sub-network, using the linear matrix, to produce a linear node value and a corresponding logic value for the shared node. The method further includes performing an event-based simulation of the logic sub-network to produce a logic value on an output node, using the logic value for the shared node as an input to the simulation of the logic sub-network.

In one embodiment, a computer implemented method of simulating a circuit includes receiving a representation of an electrical network having a digital portion and a linear portion, and generating a linear matrix for the linear portion. The method also includes simulating operation of the digital portion, including generating an event signal at the digital portion, and providing the event signal to the linear portion. The method further includes at an event step, calculating the linear matrix based on the event signal to produce a result at a node shared by the linear portion and digital portion.

In another embodiment, a computer-implemented system for performing a simulation includes one or more processors and memory storing one or more programs. The one or more programs include instructions for receiving a representation of an electrical network having a plurality of sub-networks, including a logic sub-network and a linear sub-network that share a node. The one or more programs include instructions for generating a linear matrix for the linear sub-network, and instructions for performing an event-based simulation of the linear sub-network, using the linear matrix, to produce a linear node value and a corresponding logic value for the shared node. The one or more programs further include instructions for performing an event-based simulation of the logic sub-network to produce a logic value on an output node, using the logic value for the shared node as an input to the simulation of the logic sub-network.

In another embodiment, a computer-implemented system for performing a simulation includes one or more processors and memory storing one or more programs. The one or more programs include instructions for receiving a representation of an electrical network having a digital portion and a linear portion, and include instructions for generating a linear matrix for the linear portion. The one or more programs also include instructions for simulating operation of the digital portion, including generating an event signal at the digital portion, and providing the event signal to the linear portion. The one or more programs also include instructions for calculating at an event step the linear matrix based on the event signal to produce a result at a node shared by the linear portion and digital portion.

In another embodiment, a computer readable storage medium stores instructions that, when executed on a server, cause the server to perform operations that include receiving a representation of an electrical network having a plurality of sub-networks, including a logic sub-network, and a linear sub-network that share a node. The operations further include generating a linear matrix value for the linear sub-network, and performing an event-based simulation of the linear sub-network, using the linear matrix, to produce a linear node value, and a corresponding logic value for the shared node. A further operation includes performing an event-based simulation of the logic sub-network to produce a logic value on an output node using the logic value for the shared node as an input to the simulation of the logic sub-network.

In one embodiment, a computer readable storage medium storing instructions that, when executed on a server, cause the server to perform operations that include receiving a representation of an electrical network having a digital portion and a linear portion. The operations further include generating a linear matrix for the linear portion, and simulating operation of the digital portion, including generating an event signal at the digital portion, and providing the event signal to the linear portion. A further operation includes at an event step, calculating the linear matrix based on the event signal to produce a result at a node shared by the linear portion and digital portion.

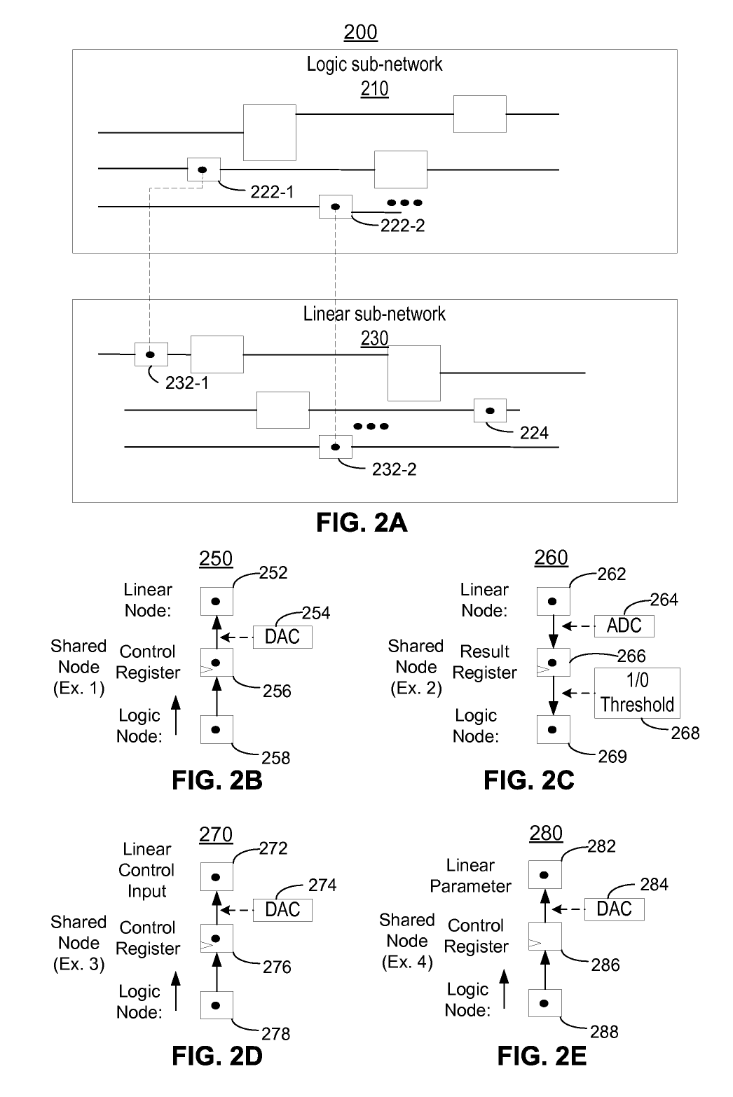

FIG. 2A is a block diagram 200 illustrating nodes shared between a logic sub-network 210 and a linear sub-network 230. Logic sub-network 210 includes a first shared node 222-1 and a second shared node 222-2. Linear sub-network 230 also includes a first node 232-1 that corresponds to the shared node 222-1 of the logic sub network 210, and a second node 232-2 that corresponds to the shared node 222-2 of the logic sub network 210. Thus, the first and second nodes (222-1/232-1 and 222-2/232-2) are shared between the logic sub-network and the linear sub-network, and a value written to a shared node by one side (e.g. the logic sub-network 210) can be read by the other side (e.g. the linear sub-network 230), and vice versa. Linear sub-network 230 also includes a result register 224, that operates as a probe or read-only function. A value at node 224 is observed, but may not be written to.

FIG. 2B is a block diagram illustrating an example of a circuit 250 (also called a circuit design) that includes a mechanism for passing values through a shared node from a logic network to a linear network. In circuit 250, which corresponds to (or implements) a shared node, a logic node 258 (in a logic sub-network) is coupled to the input of a control register 256. The logic node 258 may be a single bit node having a single bit value, or it may be a multi-bit node (e.g., the output node of a register or counter) having a multiple-bit value. The output of control register 256 is coupled to a linear node 252 (in a linear sub-network). Thus, the control register 256 operates as a shared node between the logic node 258 of a logic sub-network 210 and the linear node 252 of linear sub-network 230. From another viewpoint, the control register 256, the logic node 258 and the linear node 252 together implement a shared node. In some embodiments, a digital to analog conversion (DAC) function 254 is coupled between control register 256 and linear node 252. The DAC function converts a digital value (e.g., a 0 or 1 logic value; or a multi-bit value from a register, a counter or the like) from the digital (logic) domain to an analog value (e.g., a voltage or current value) in the analog (linear) domain. In an embodiment, an input to the DAC function has an adjustable number of bits. In one example, the number of bits of the DAC function's input is determined by HDL code, one example of which is Verilog code.

FIG. 2C is a block diagram illustrating an example of a circuit 260 (also called a circuit design) that includes a mechanism for passing values through a shared node from a linear network to a logic network. In circuit 260, which corresponds to or implements a shared node, a linear node 262 is coupled to the input of a result register 266. The output of result register 266 is coupled to a logic node 269. Thus, the result register 266 operates as a shared node between the linear node 262 of a linear sub-network 230 and the logic node 269 of logic sub-network 210. From another viewpoint, the result register 266, the linear node 262 and the logic node 269 together implement a shared node. In one embodiment, an analog to digital conversion (ADC) function 264 is coupled between linear node 262 and result register 266. The ADC function 264 converts an analog value (e.g., an observed voltage, observed current value, or other observed analog circuit parameter) from the analog (linear) domain to the digital (logic) domain. In some embodiments, the output of the ADC function 264 has an adjustable number of bits. In an embodiment, the output of the ADC function has a number of bits determined by HDL code, for example Verilog code. In various embodiments, instances of the result register 266 are used to convey single bit representations or multi-bit representations of linear values to the logic sub-network 210. In an embodiment, a linear branch current can be passed from linear node 262 through result register 266 to the logic sub-network node 269. For example, the linear branch current may be converted to a digital value by the ADC function 264, and then compared with a threshold value by a threshold function 268, as described next.

Furthermore, in some embodiments, a threshold function 268 is coupled between result register 266 and logic node 269. When present, the threshold function 268 analyzes the value from the result register 266, determines if it meets predefined criteria with respect to a threshold value, and then sets the logic value of logic node 269 to a logic one value or a logic zero value in accordance with the determination. Four examples of the predefined criteria are: greater than (>) the threshold value, greater than or equal (≧) to the threshold value, less than (<) the threshold value, and less than or equal (≦) to the threshold value. Other examples of predefined criteria may be used in other embodiments; for example the predefined criteria may utilize criteria with respect to two or more threshold or limit values. The threshold value(s) and the predefined criteria of the threshold function are determined by the user or designer of the circuit.

FIG. 2D is a block diagram illustrating an example of a circuit 270 (also called a circuit design) that includes a mechanism for passing values through a shared node from a node 278 of a logic sub-network 210 to a linear control input 272 of a circuit element in a linear sub-network 230. The node 278 may provide a single binary value, or a multiple-bit value, such as the output of a counter or a register. The circuit 270 may optionally include a digital to analog (DAC) converter 274 that converts the binary or multiple-bit value on node 278 into an analog value of the control input 272.

FIG. 2E is a block diagram illustrating an example of a circuit 280 (also called a circuit design) that includes a mechanism for passing values through a shared node from a node 288 of a logic sub-network 210 to a linear parameter 282 (e.g., a threshold parameter, gain parameter, voltage or current parameter, etc.) of a circuit element in a linear sub-network 230. The node 288 may provide a single binary value, or a multiple-bit value, such as the output of a counter or a register. The circuit 280 may optionally include and digital to analog (DAC) converter 284 that converts the binary or multiple-bit value on node 288 into an analog value of the linear parameter 282.

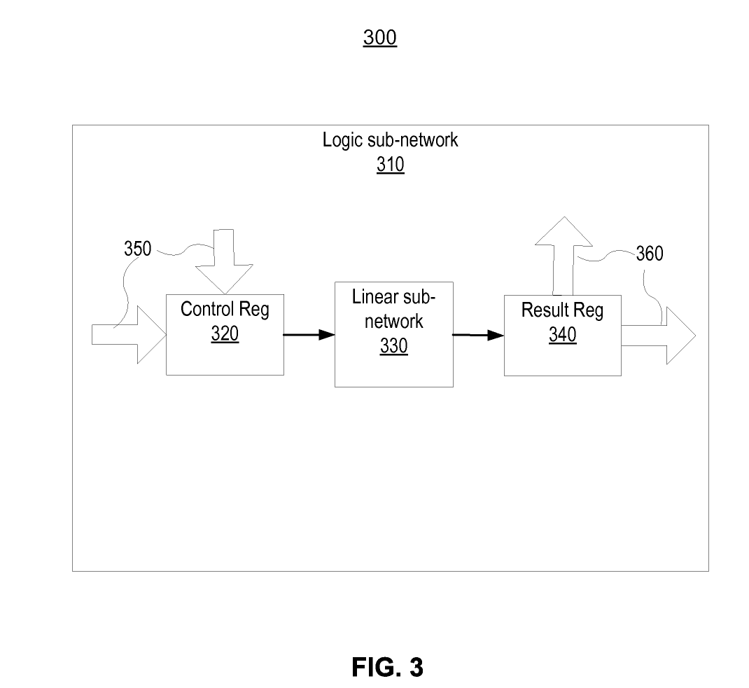

FIG. 3 is a block diagram 300 illustrating a logic sub-network 310 having an embedded linear sub-network 330 with shared nodes for passing values into and out of the linear sub-network 330. The shared nodes include a control register 320 receiving signals 350 from the logic sub-network 310, and a result register 340 for providing results 360 to the logic sub-network 310. In an embodiment, the control register 320 may correspond to the shared node of circuit 250 (FIG. 2B). In an embodiment, the result register 340 may correspond to the shared node of circuit 260 (FIG. 2C).

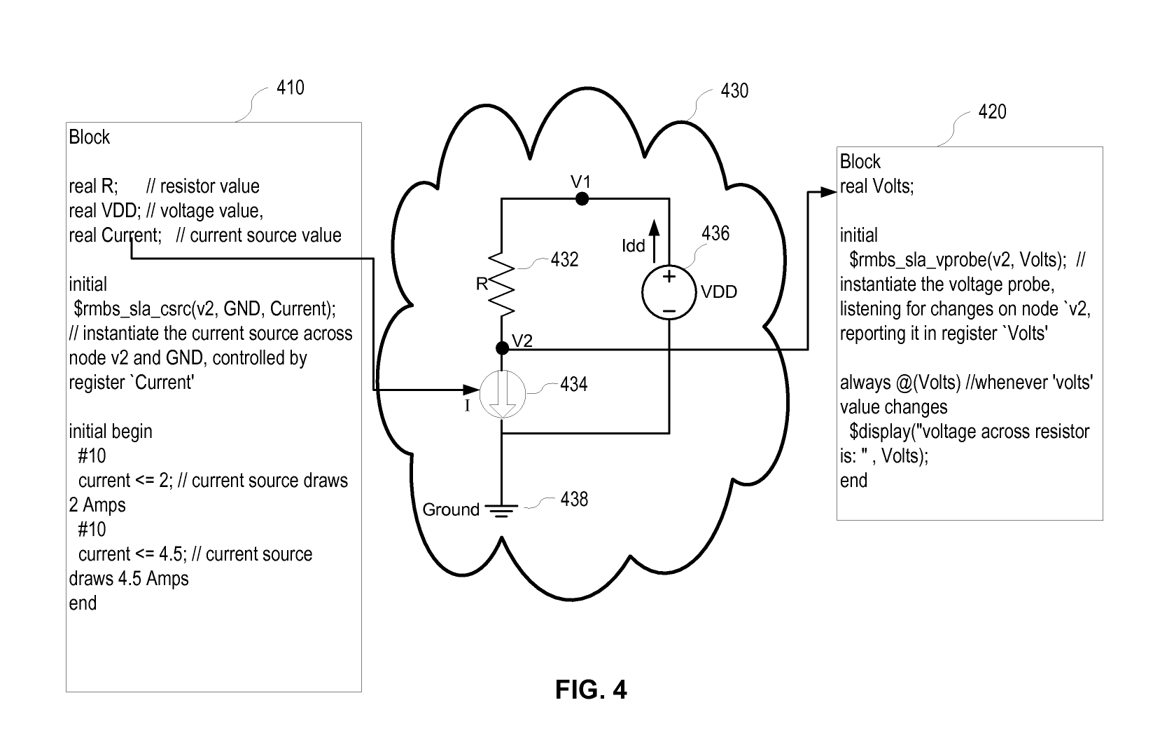

FIG. 4 is a block diagram illustrating a linear circuit 430 driven by and monitored by Verilog code. The linear circuit 430 includes a resistor 432, a current source 434 coupled between one side of the resistor 432 (at node V2) and circuit ground 438, and a voltage source 436 is coupled between the other side of the resistor 432 (at node V1) and circuit ground 438. Verilog code 410 instantiates registers to control values of the resistor 432(R), voltage source 436 (VDD), and current source 434 (Current). The Verilog code 410 instantiates the current source 434 across node V2 and circuit ground 438, with a current source value (which sets the amount of current produced by the current source) controlled by register ‘Current’. Verilog code 410 initially sets the current source 434 to a first value (2 amps) and then sets the current source 434 to a second value (4.5 amps). Thus, Verilog code 410 drives the linear network 430.

In FIG. 4, Verilog code 420 monitors the linear circuit 430 and reports on the voltage value produced at the positive node of the voltage source 436. The Verilog code 410 instantiates a register ‘Volts’ to receive a voltage value from the node V2 between resistor R and current source 434. The Verilog code 420 instantiates the voltage probe, listening for changes in the voltage on node V2, and reporting the voltage on node V2 in register ‘Volts’. In Verilog code 420, whenever the voltage value V2 at the base of resistor 432 changes, it is displayed, for example on a display on a workstation. During an event-based simulation of the linear circuit of FIG. 4, if an input to linear circuit 430 changes, then the circuit 430 is scheduled for evaluation at the end of the current event step. In an embodiment, the linear circuit 430 is updated in a single event step during the simulation. In an extension of this example, when the event-based simulation of the linear circuit 430 produces a voltage value on node V2, that voltage value may be converted into a digital value and stored in a result register. And when the value in the result register changes in value, that change may prompt a logic sub-network to be scheduled for evaluation.

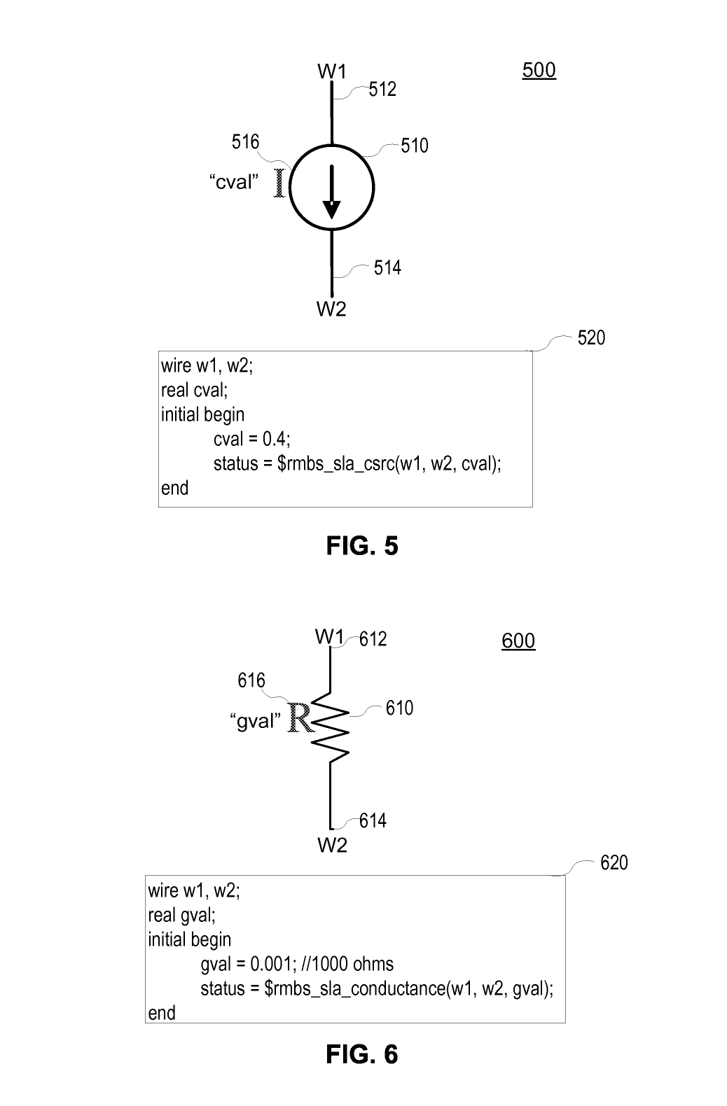

FIG. 5 depicts a Verilog model 500 of a linear current source 510. The linear current source model 500 includes a current source 510 coupled between a first wire 512 (w1) and second wire 514 (w2). The model 500 includes a current value 516 (cval) that specifies the amount of current that flows through the current source 510 from the first wire 512 to the second wire 514. Verilog code 520 models the instantiation of a linear current source in accordance with this model 500.

FIG. 6 depicts a Verilog model 600 of a linear resistor 610. The linear resistor model 600 includes a linear resistor 610 coupled between a first wire 612 (w1) and second wire 614 (w2). The model 600 includes a resistance value 616 (gval), which represents the resistance, in units of ohms, of the linear resistor 610. Verilog code 620 models the instantiation of a linear resistor in accordance with this model 600.

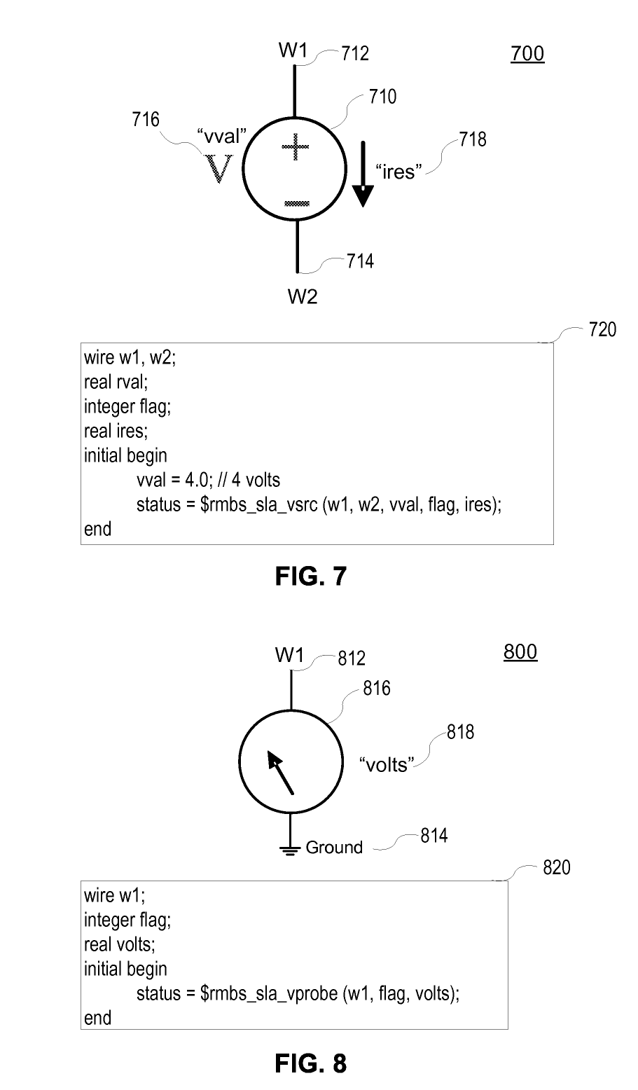

FIG. 7 depicts a Verilog model 700 of a linear voltage source 710. The linear voltage source model 700 includes linear voltage source 710 coupled between a first wire 712 (w1) and second wire 714 (w2). The model 700 includes a voltage value 716 (vval) that represents (or specifies) the voltage difference between a voltage on the first wire 710 and a voltage on the second wire 714. The model 700 may also include a current value 718 (ires), which represents current flowing through the voltage source 710. This current value 718 can be read (observed) by a program, but cannot set by the program since it is a result. Verilog code 720 models the instantiation of a linear voltage source in accordance with this model 700.

FIG. 8 depicts a Verilog model 800 of a linear voltage probe. The linear voltage probe model 800 includes a line voltage probe 816 coupled between a first wire 812 (w1) and a ground connection 814 (Ground). The model 800 includes a voltage value 818 (volts) that represents a voltage on the first wire 812. Verilog code 820 models the instantiation of a voltage probe in accordance with this model 800.

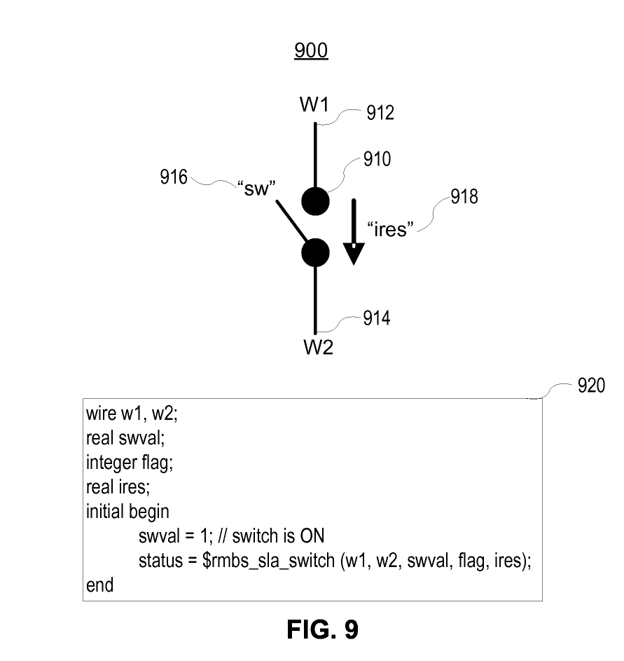

FIG. 9 depicts a Verilog model 900 of an ideal linear switch. The linear switch model includes a switch 910 coupled between a first wire 912 (w1) and second wire 914 (w2). The model 900 includes a state on/off value 916 (sw), and optionally includes a current value 918 (ires) that represents the current flowing through the switch 910. Verilog code 920 models the instantiation of a switch in accordance with this model 900. In this model 900, the state on/off value 916 is a control parameter that can be set by a program or the like, while the current value 918 is a monitoring parameter whose value can be read by a program, but which cannot be set by the program. The current value 918 (of switch 910) may be used as the analog portion of a shared node, shared between linear and logic sub-networks, in which case the monitored current value 918 may be converted to a digital value and stored in a result register that is coupled to a node in a logic sub-network. This methodology can also be used with any of the observed or monitored linear circuit values discussed elsewhere in this document.

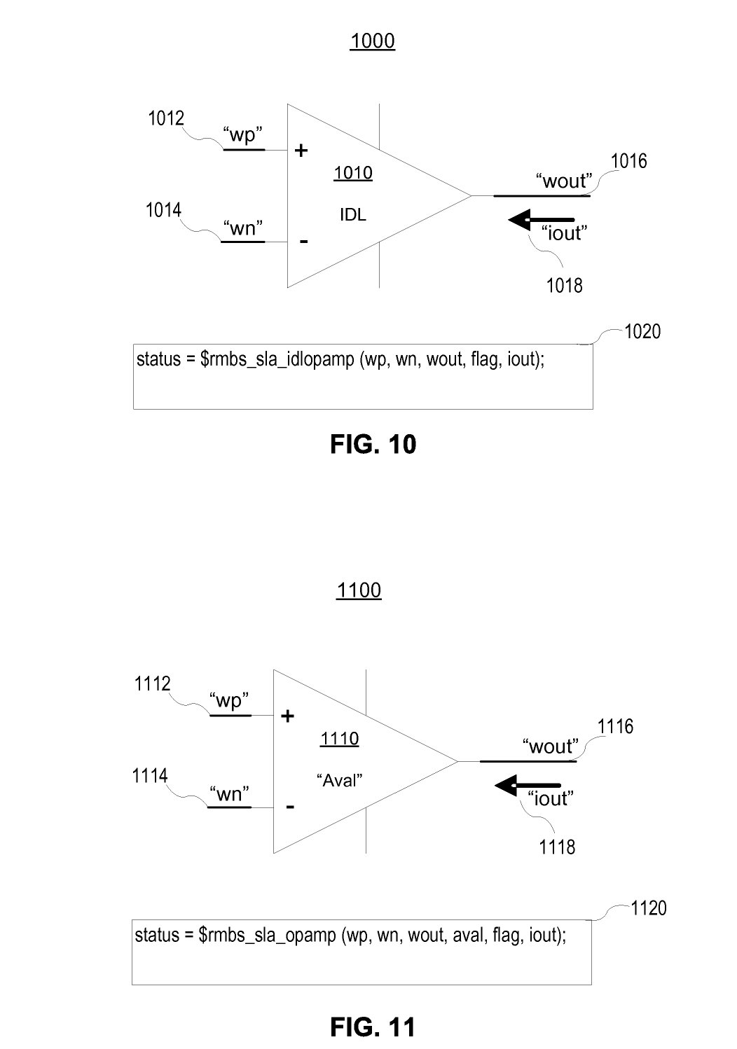

FIG. 10 depicts a Verilog model 1000 of an ideal operational amplifier. The ideal operational amplifier model includes an operational amplifier 1010 having a unity gain, and having a first input 1012 (wp), a second input 1014 (wn), and an output 1016 (wout). The model 1000 includes a current value 1018 (iout), which represents the amount and direction of current flowing through the operational amplifier's output 1016. This current value 1018 can be read (observed) by a program, but cannot set by the program since it is a result. Verilog code 1020 models the instantiation of a ideal operational amplifier in accordance with this model 1000.

FIG. 11 depicts a Verilog model 1100 of a linear operational amplifier having adjustable gain. The linear operational amplifier model 1100 includes an operational amplifier 1110 having a first input 1112 (wp), a second input 1114 (wn), and an output 1116 (wout). The model 1100 includes an adjustable gain value (Aval), which sets the gain of the linear operational amplifier, and a current value 1118 (iout) that represents the amount and direction of current flowing through the operational amplifier's output 1116 in accordance with a predefined linear relationship (e.g., iout=Aval·(wp−wn)). This current value 1118 can be read (observed) by a program, but cannot set by the program since it is a result. Verilog code 1120 models the instantiation of a linear operational amplifier in accordance with this model 1100.

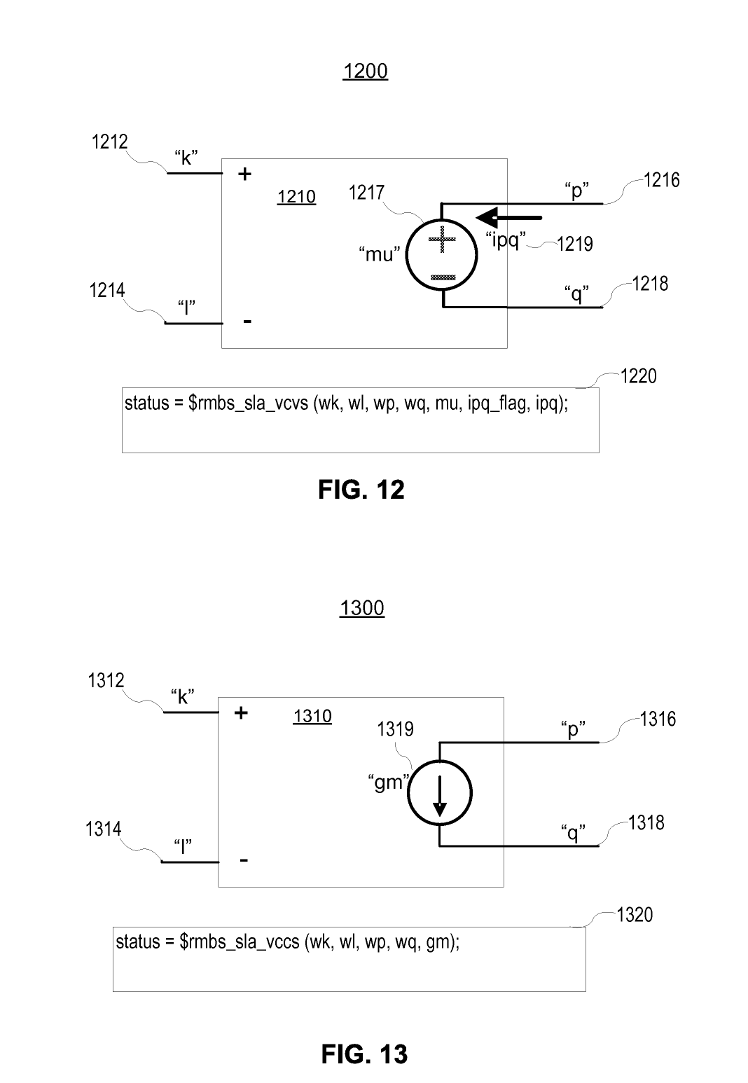

FIG. 12 depicts a Verilog model 1200 of a linear voltage controlled voltage source 1210. In this model 1200, the linear voltage controlled voltage source 1210 includes a voltage source 1217 having a voltage value (mu). The voltage source 1217 has a positive terminal (p) 1216, and a negative terminal (q) 1218. The model 1200 includes a current 1219 (ipq) that flows through the voltage source 1217. This current 1219 can be read (observed) by a program, but cannot set by the program since it is a result. The linear voltage controlled voltage source 1210 has a first (or plus (+)) input 1212 (k) and a second (or minus (−)) input 1214 (l). The voltage (vinput) across the inputs 1212 and 1214 determines the voltage gain (mu) produced by the voltage source 1217 in accordance with a predefined linear relationship (e.g., mu=γ·vinput). Verilog code 1220 models the instantiation of a linear voltage controlled voltage source 1210 in accordance with this model 1200.

FIG. 13 depicts a Verilog model 1300 of a linear voltage controlled current source 1310. In this model 1300, the linear voltage controlled current source 1310 includes a current source 1319 that sources or drives a variable amount of current (gm). The current source 1319 has a positive terminal (p) 1316 and a negative terminal (q) 1318. The linear voltage controlled current source 1310 has a first input 1312 (k) and a second input 1314 (l). The voltage (vi) across the inputs 1312 and 1314 determines the transconductance (gm) that the current source 1319 drives between the positive and negative terminals 1316, 1318 in accordance with a predefined linear relationship (e.g., i_{pq}=gm·V_{KL}). Verilog code 1320 models the instantiation of a linear voltage controlled current source 1310 in accordance with this model 1300.

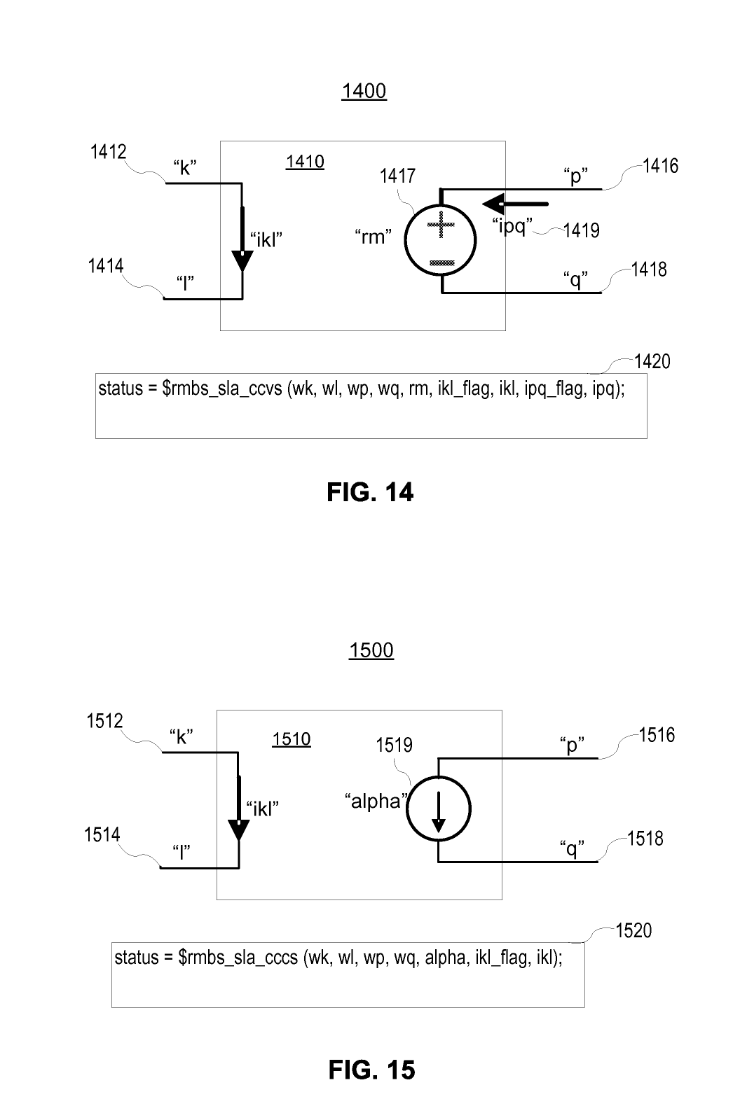

FIG. 14 depicts a Verilog model 1400 of a linear current controlled voltage source 1410. In this model 1400, the linear current controlled voltage source 1410 includes a voltage source 1417 having a transresistance (rm). The voltage source 1419 has a positive terminal (p) 1416 and a negative terminal (q) 1418. A current 1419 (ipq) flows through the voltage source 1417. The linear current controlled voltage source 1410 has a first input 1412 (k) and a second input 1414 (l). The current value (ikl) flowing through the inputs 1412 and 1414 determines the voltage (rm) produced by the voltage source 1417 in accordance with a predefined linear relationship (e.g., V_{pq}=rm·i_{KL}). Verilog code 1420 models the instantiation of a linear current controlled voltage source in accordance with this model 1400.

FIG. 15 is a diagram 1500 of a Verilog model of a linear current controlled current source 1510. The linear current controlled current source 1510 includes a current source 1519 having a current gain (alpha). The current source 1519 has a positive terminal (p) 1516, and a negative terminal (q) 1518. The linear current controlled current source 1510 has a first input 1512 (k) and a second input 1514 (l). The current value (ikl) flowing through the inputs 1512 and 1514 determines the amount of current (alpha) driven by the current source 1519 through the positive and negative terminals 1516, 1518 in accordance with a predefined linear relationship (e.g., i_{pq}=α·i_{KL}). Verilog code 1520 models the instantiation of a linear current controlled current source in accordance with this model 1500.

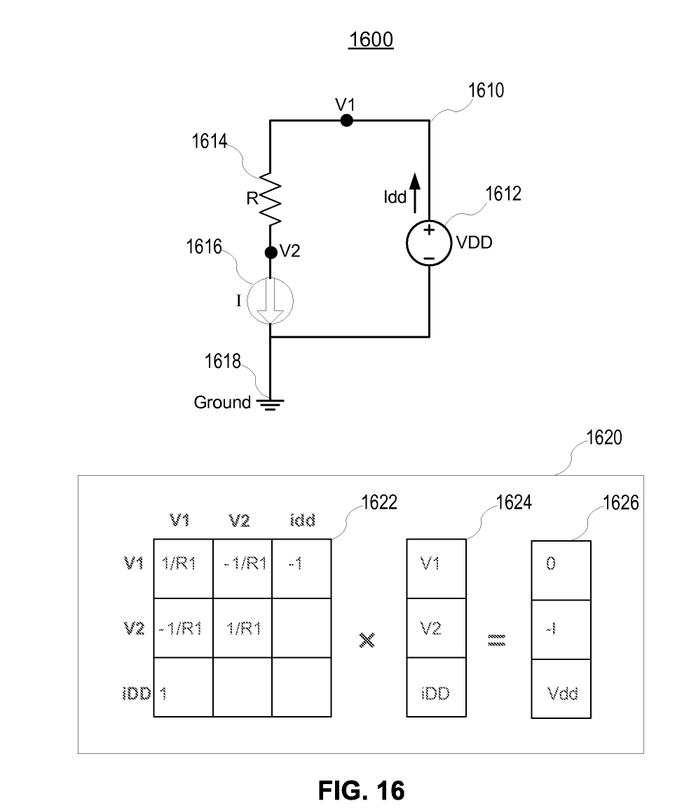

FIG. 16 depicts a Verilog model 1600 of a linear circuit and its linear matrix representation. The linear circuit includes a resistor 1614, a current source 1616 coupled between a second node (V2) of the resistor 1614 and circuit ground 1618, and a voltage 1612 coupled between a first node 1610 (V1) of the resistor 1614 and circuit ground 1618. The circuit of FIG. 16 corresponds to the linear circuit 430 of FIG. 4. A linear matrix equation 1620 represents the state of the linear circuit 1600. Linear matrix equation 1620 produces a matrix product 1626 by multiplying linear matrix elements 1622 and 1624. In an embodiment, the linear matrix equation 1620 is updated in a single event step during simulation of the circuit 1600. In an embodiment, the linear circuit can have resistive, capacitive and inductive elements. In an embodiment the linear matrix is simulated to produce values for reporting and communicating with a logic sub-network.

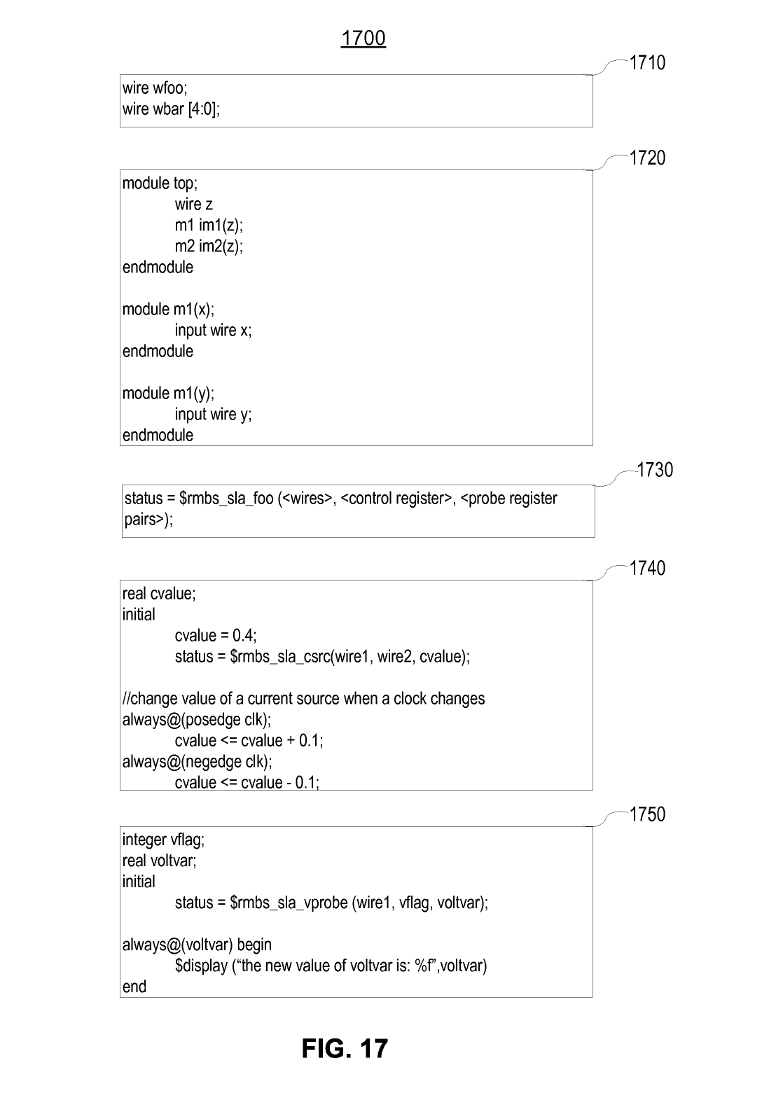

FIG. 17 depicts examples of Verilog code 1700 to map linear values to and from wires. The Verilog code examples shown in FIG. 17 include Verilog code for a wire 1710, a net 1720, a device instance 1730, a control register 1740, and a register result pair 1750.

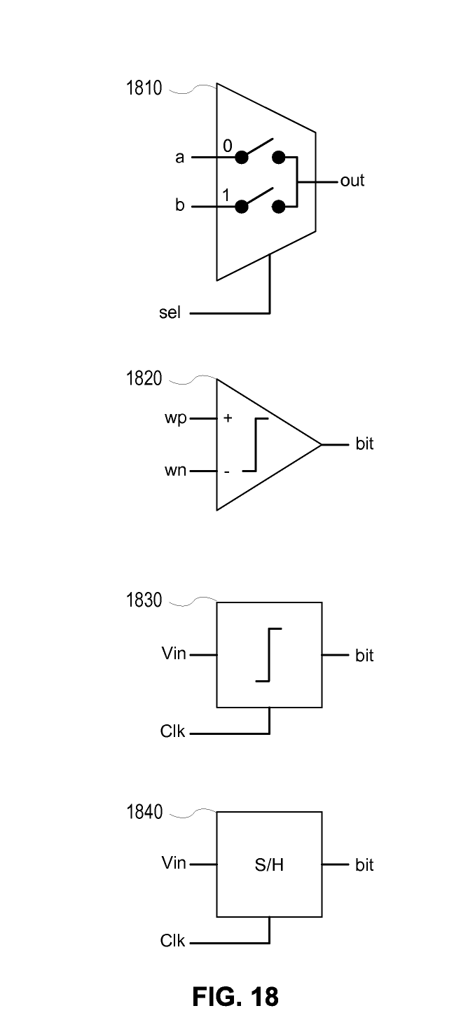

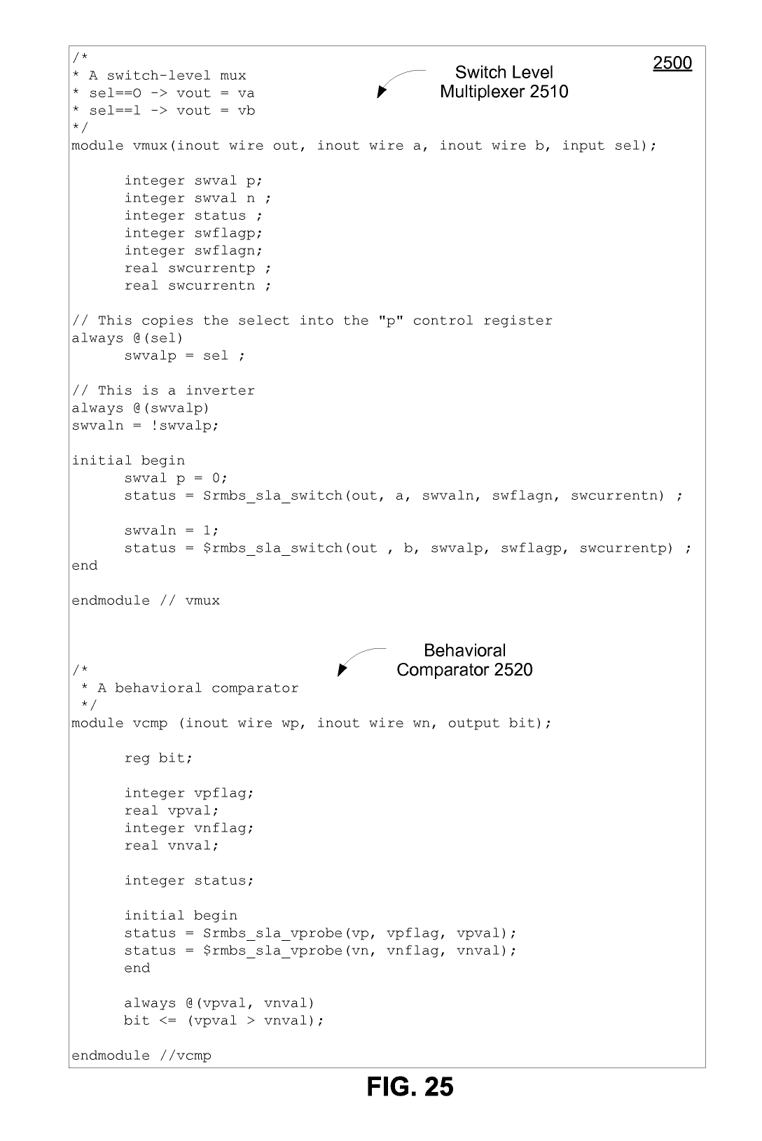

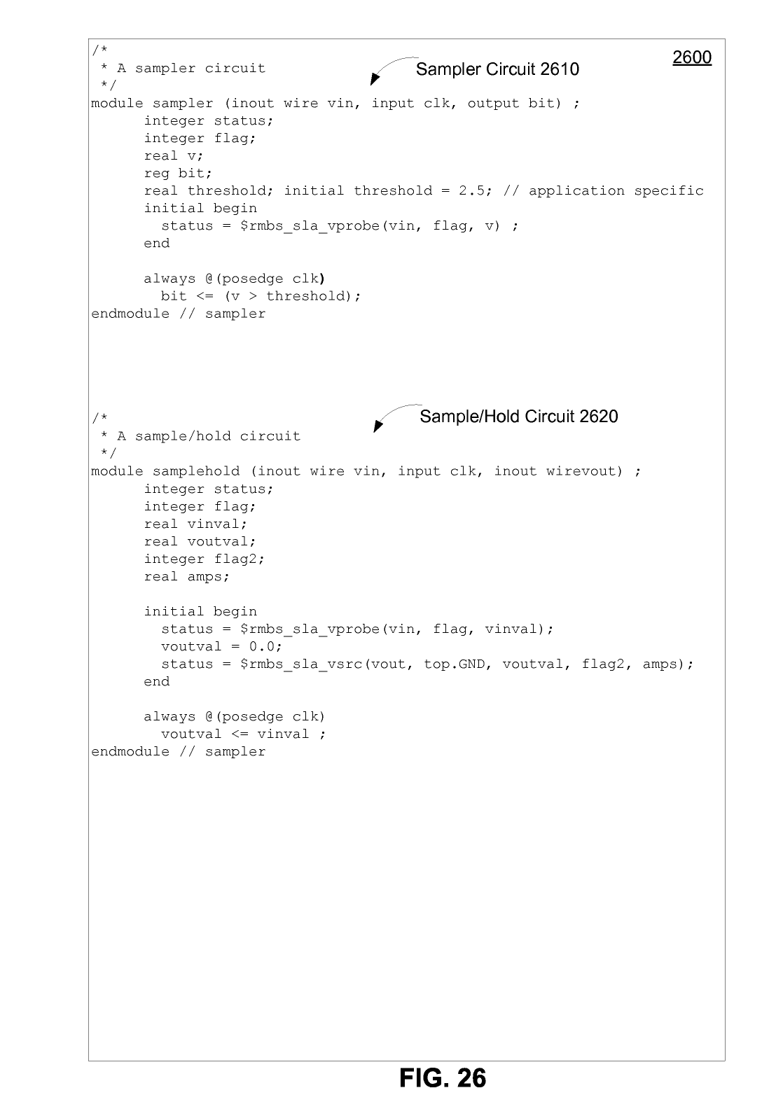

FIG. 18 depicts examples of composite analog components formed from linear circuits. An analog multiplexer 1810 is shown, along with a comparator 1820, an input sampler 1830, and sample and hold circuit 1840. Verilog code for analog multiplexer 1810 is shown in code 2510 of FIG. 25. Verilog code for analog comparator 1820 is shown in code 2520 of FIG. 25. Verilog code for input sampler 1830 is shown in code 2610 of FIG. 26. Verilog code for sample and hold circuit 1840 is shown in code 2620 of FIG. 26.

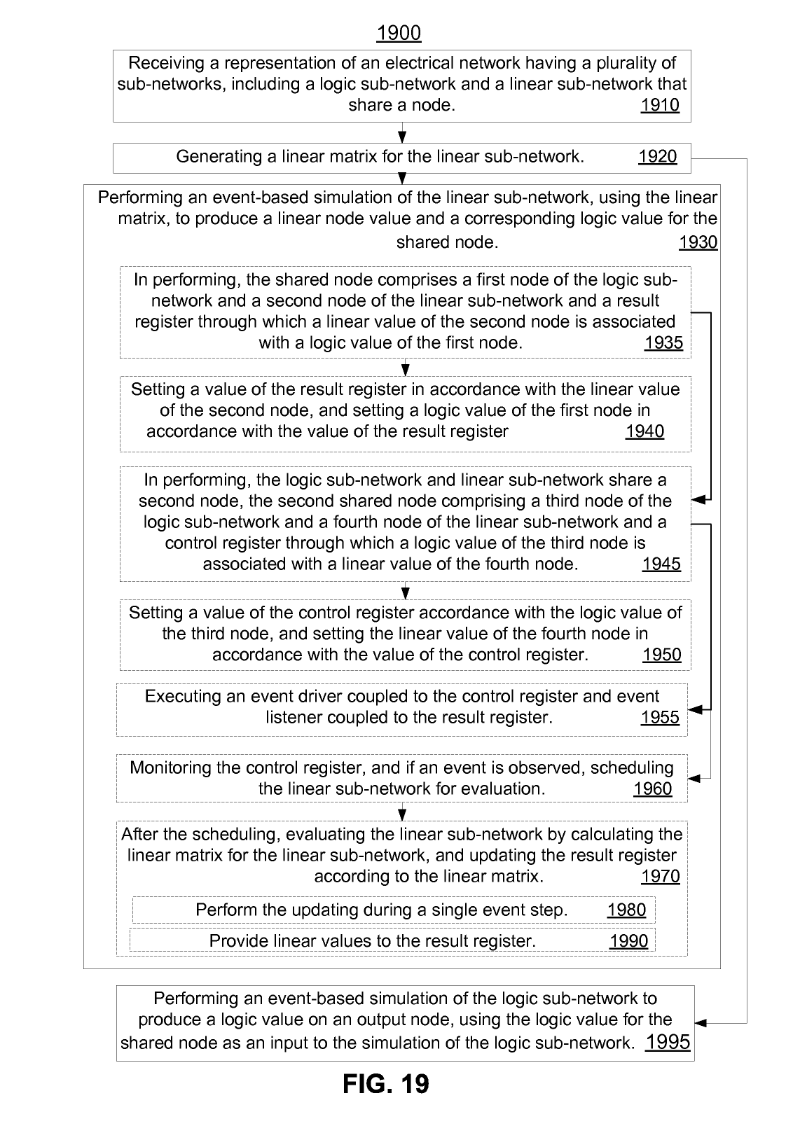

FIG. 19 is a flowchart of a method 1900 of simulating a circuit including a linear sub-network and a logic sub-network that share a node. The method includes receiving 1910 a representation of an electrical network having a plurality of sub-networks, including a logic sub-network and a linear sub-network that share a node. The method further includes generating 1920 a linear matrix for the linear sub-network, and performing 1930 an event-based simulation of the linear sub-network, using the linear matrix, to produce a linear node value and a corresponding logic value for the shared node. In addition, the method includes performing 1995 an event-based simulation of the logic sub-network to produce a logic value on an output node, using the logic value for the shared node as an input to the simulation of the logic sub-network.

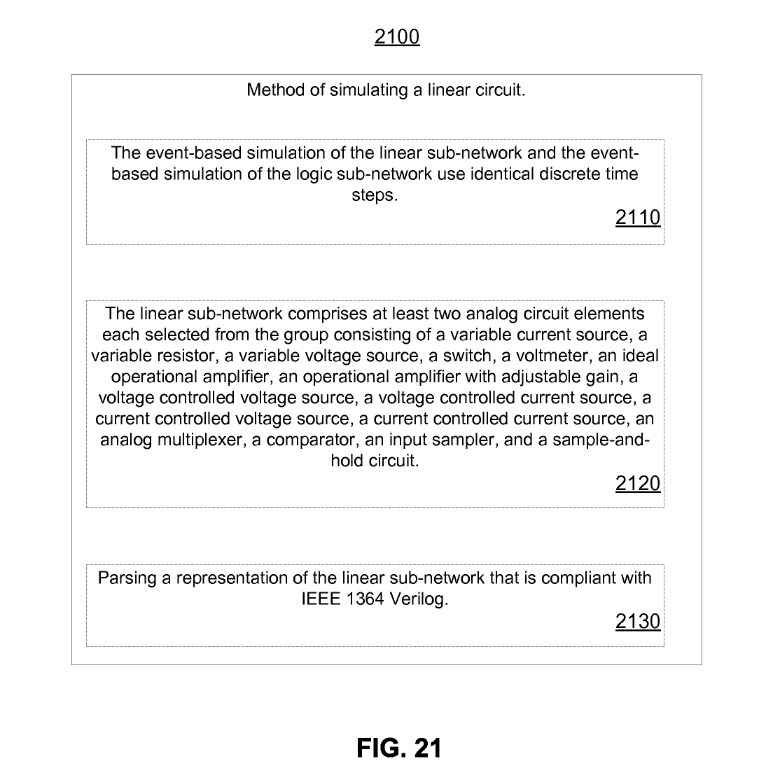

In an embodiment, method 1900 includes using identical discrete time steps for the event-based simulation of the linear sub-network and the event-based simulation of the logic sub-network (2110, FIG. 21). Optionally, the shared node includes a first node of the logic sub-network and a second node of the linear sub-network and a result register through which a linear value of the second node is associated with a logic value of the first node (1935). A value of the result register is set in accordance with the linear value of the second node, and wherein the logic value of the first node is set in accordance with the value of the result register (1940). In some embodiments, the logic sub-network and linear sub-network share a second node, the second shared node comprising a third node of the logic sub-network, a fourth node of the linear sub-network, and a control register through which a logic value of the third node is associated with a linear value of the fourth node (1945). A value of the control register is set in accordance with the logic value of the third node, and the linear value of the fourth node is set in accordance with the value of the control register (1950). Furthermore, in some embodiments, an event driver coupled to the control register is executed and an event listener coupled to the result register is executed (1955). Furthermore, the control register may be monitored and if an event is observed, the linear sub-network is scheduled for evaluation (1960). In some embodiments, after the linear sub-network is scheduled for evaluation, it is evaluated by calculating the linear matrix for the linear sub-network, and updating the result register according to the linear matrix (1970). The updating is optionally performed during a single event step (1980). Furthermore, linear values may be provided to the result register as part of updating it according to the linear matrix (1990).

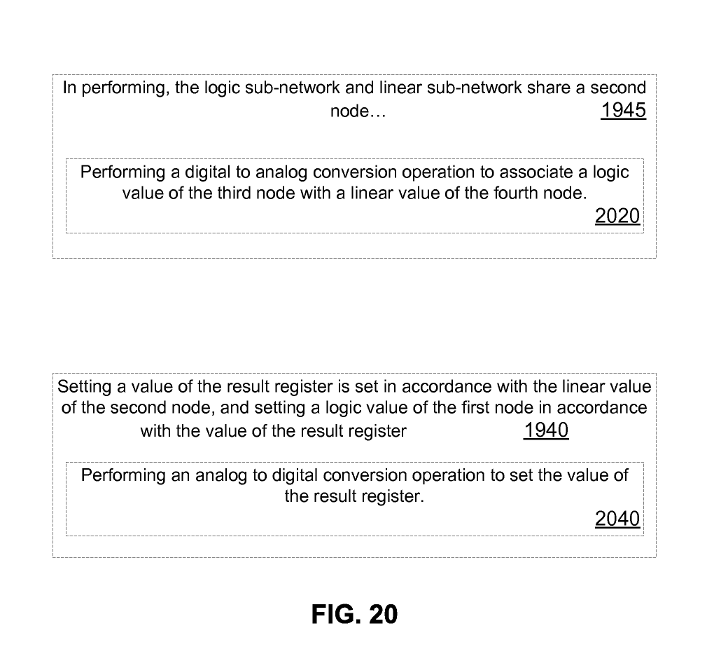

FIG. 20 is a flowchart of a method of simulating a circuit including performing conversions between an analog domain and a digital domain. In some embodiments operation 1945 includes performing a digital to analog conversion operation to associate a logic value of the third node with a linear value of the fourth node (2020). Similarly, in some embodiments operation 1940 includes setting the value of the result register including performing an analog-to-digital conversion operation (2040).

FIG. 21 is a flowchart of a method 2100 of simulating a circuit including a linear sub-network and a logic sub-network that share a node. In this method, identical discrete time steps are used for the event-based simulation of the linear sub-network and the event-based simulation of the logic sub-network (2110). The method optionally includes simulating in the linear sub-network at least two analog circuit elements each selected from the group consisting of a variable current source, a variable resistor, a variable voltage source, a switch, a voltmeter, an ideal operational amplifier, an operational amplifier with adjustable gain, a voltage controlled voltage source, a voltage controlled current source, a current controlled voltage source, a current controlled current source, an analog multiplexer, a comparator, an input sampler, and a sample-and-hold circuit (2120). Further, the method 2100 optionally includes parsing a representation of the linear sub-network that is compliant with IEEE 1364 Verilog (2130). IEEE 1364 Verilog is the most widely supported Verilog format, and has a wider installed tool base than any other Verilog format. A different and less widely supported Verilog format is Verilog Analog Mixed Signal (AMS), which is defined in “IEEE 1364 Verilog Standard Extension.”

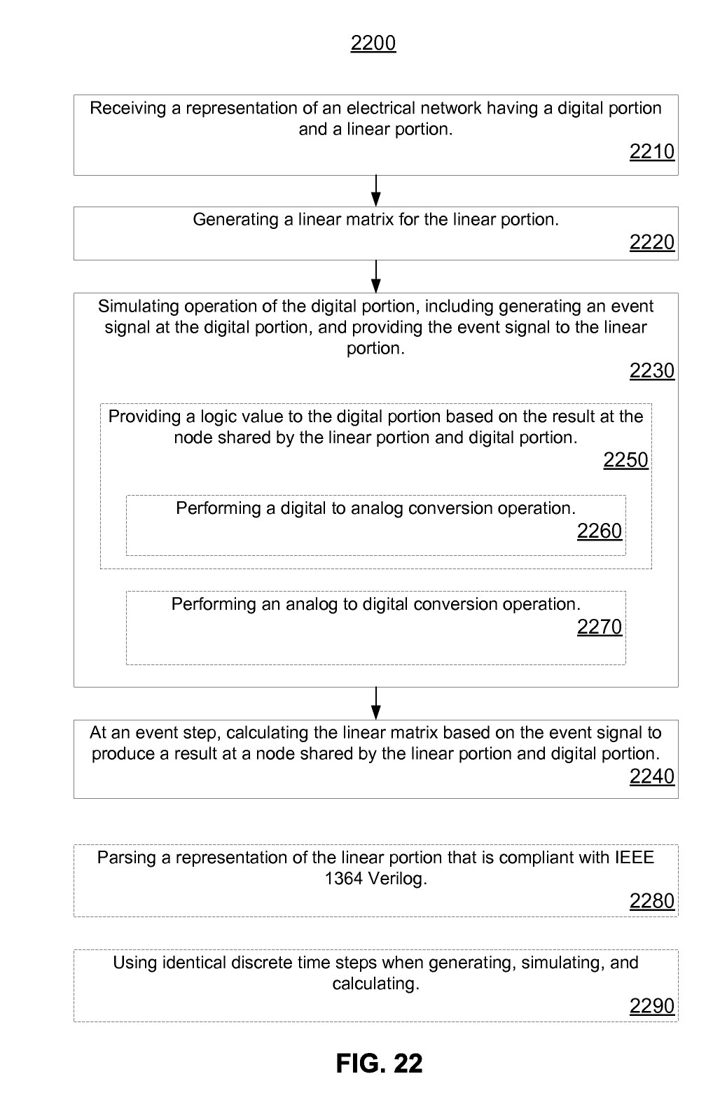

FIG. 22 is a flowchart of a computer implemented method 2200 of simulating a circuit including a linear portion and a logic portion that share a node. The method 2200 includes receiving a representation of an electrical network having a digital portion and a linear portion (2210), generating a linear matrix for the linear portion (2220), and simulating operation of the digital portion, including generating an event signal at the digital portion, and providing the event signal to the linear portion (2230). At an event step, the linear matrix is calculated based on the event signal to produce a result at a node shared by the linear portion and digital portion (2240). The method optionally includes parsing a representation of the linear portion that is compliant with IEEE 1364 Verilog (2280), and optionally includes using identical discrete time steps when generating, simulating, and calculating (2290). Operation 2230 may include providing a logic value to the digital portion based on the result at the node shared by the linear portion and the digital portion (2250), which may include performing a digital to analog conversion (2260). Similarly, operation 2230 optionally includes performing an analog to digital conversion operation (2270).

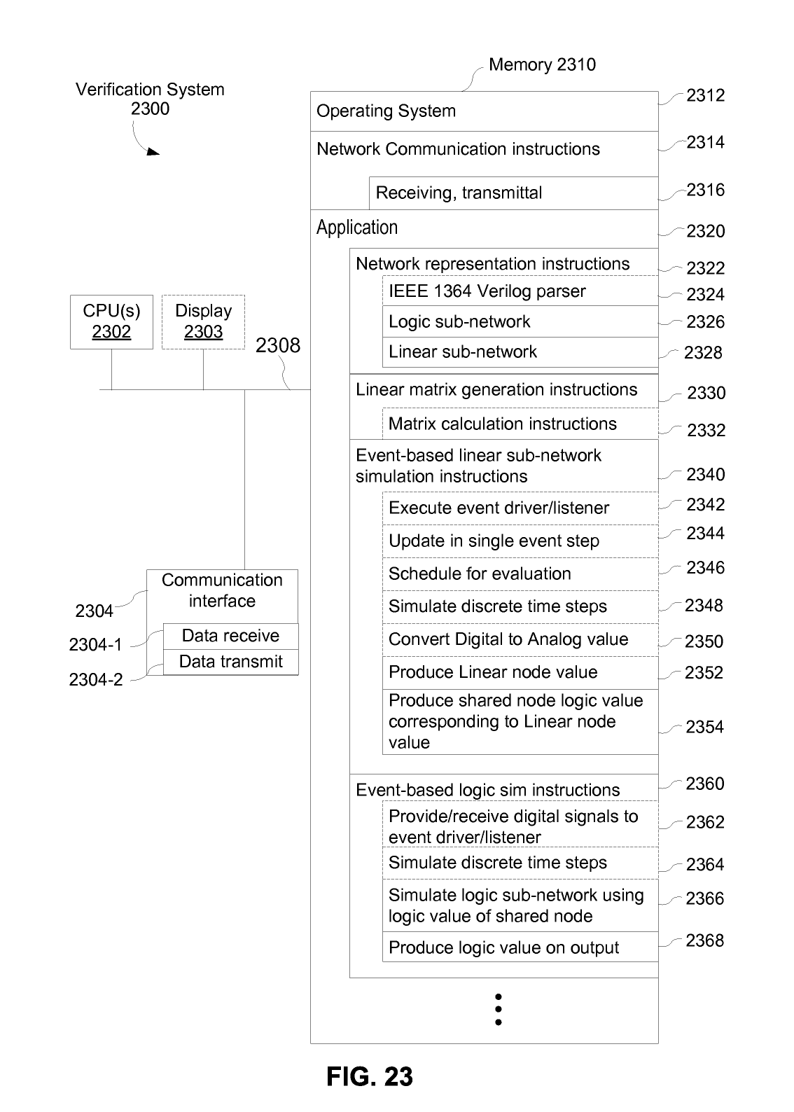

FIG. 23 is a block diagram of a verification system 2300 (e.g., a server, a workstation, or other computer system) for simulating a circuit. Verification system 2300 includes one or more processing units (CPU's) 2302, and one or more network communication interfaces 2304 having a data receive function 2304-1 and data transmit function 2304-2. Verification system 2300 also includes memory 2310 and one or more communication buses 2308 for interconnecting these components. In some embodiments the communication buses 2308 include circuitry (sometimes called a chipset) that interconnects and controls communications between system components. Memory 2310 includes high speed random access memory and also includes non-volatile memory such as one or more magnetic or optical disk storage devices or solid state storage devices such as Flash memory or magnetic random access memory (MRAM). Memory 2310 optionally includes one or more storage devices remotely located from the CPU(s) 2302.

In some embodiments, the system 2300 includes a display 2303 that is local to the system 2300, while in other embodiments the system includes, utilizes or sends information to a display 2303 that is located remotely from the system 2300. For example the display 2303 may be part of a workstation or other computer located across a network. Alternately, the display 2303 may be a network connected device to which system 2300 sends information.

Memory 2310, or alternately the non-volatile memory device(s) within memory 2310, comprises a computer readable storage medium. In some embodiments, memory 2310 stores the following programs, modules and data structures, or a subset or superset thereof:
an operating system 2312 that includes procedures for handling various basic system services and for performing hardware dependent tasks;
a network communications module (or instructions) 2314 that is used for connecting verification system 2300 to other computers via one or more communications network interfaces (wired or wireless) and one or more communications networks, such as the Internet, other wide area networks, metropolitan area networks, and local area networks. The network communications module 2314 includes receiving and transmittal instructions 2316 for implementing the above connections.
an application 2320 having one or more procedures, programs or sets of instructions for implementing certain aspects of the verification system.

In an embodiment, the application 2320 includes network representation instructions 2322 for accessing or receiving a representation of an electrical network or circuit design having a plurality of sub-networks. In an embodiment, the representation of the electrical network is in IEEE 1364 Verilog. In an embodiment, the network representation instructions 2322 optionally include a parser 2324 for parsing the IEEE 1364 Verilog representation of the electrical network. The plurality of sub-networks includes a logic sub-network 2326 and a linear sub-network 2328 that share a node.

The application 2320 also includes linear matrix generation instructions 2330 for generating a linear matrix for the linear sub network. The linear matrix generation instructions 2330 optionally include matrix calculation instructions 2332 for calculating a value of the linear matrix representing the linear sub-network.

The application 2320 also includes event-based linear sub-network simulation instructions 2340 for simulating the linear sub-network. Simulation instructions 2340 optionally include instructions 2342 to execute the event driver/listener. Simulation instructions 2340 optionally include one or more of the following: instructions 2344 to update the linear sub-network simulation in a single event step, instructions 2346 to schedule the linear sub-network for evaluation, instructions 2348 to simulate the linear sub-network in discrete time steps, and instructions 2350 to perform a digital to analog conversion (DAC) to convert a digital (logic) value to an analog (linear) value. Simulation instructions 2340 include instructions 2352 to produce a linear node value, and instructions 2354 to produce a shared node logic value corresponding to the linear node value.

The application 2320 also includes event-based logic simulation instructions 2360 for simulating the logic sub-network. Simulation instructions 2360 optionally include instructions 2362 to provide or receive digital signals to an event driver or event listener, and optionally include instructions 2364 to simulate the logic sub-network using discrete time steps. Simulation instructions 2360 include instructions 2366 to simulate a logic sub-network using a logic value of the shared node, and instructions 2368 to produce a logic value on an output.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 2310 may store a subset of the modules and data structures identified above. Furthermore, memory 2310 may store additional modules and data structures not described above.

Although FIG. 23 shows a verification system 2300, FIG. 23 is intended more as functional description of the various features which may be present in a workstation, a set of workstations, or a set of servers, than as a structural schematic of the embodiments described herein. In practice, and as recognized by those of ordinary skill in the art, items shown separately could be combined and some items could be separated. For example, some items shown separately in FIG. 23 could be implemented on single servers or workstations and single items could be implemented by one or more servers or workstations. The actual number of servers or workstations used to implement system 2300 and how features are allocated among them will vary from one implementation to another, and may depend in part on the amount of data traffic that the system must handle during peak usage periods as well as during average usage periods.

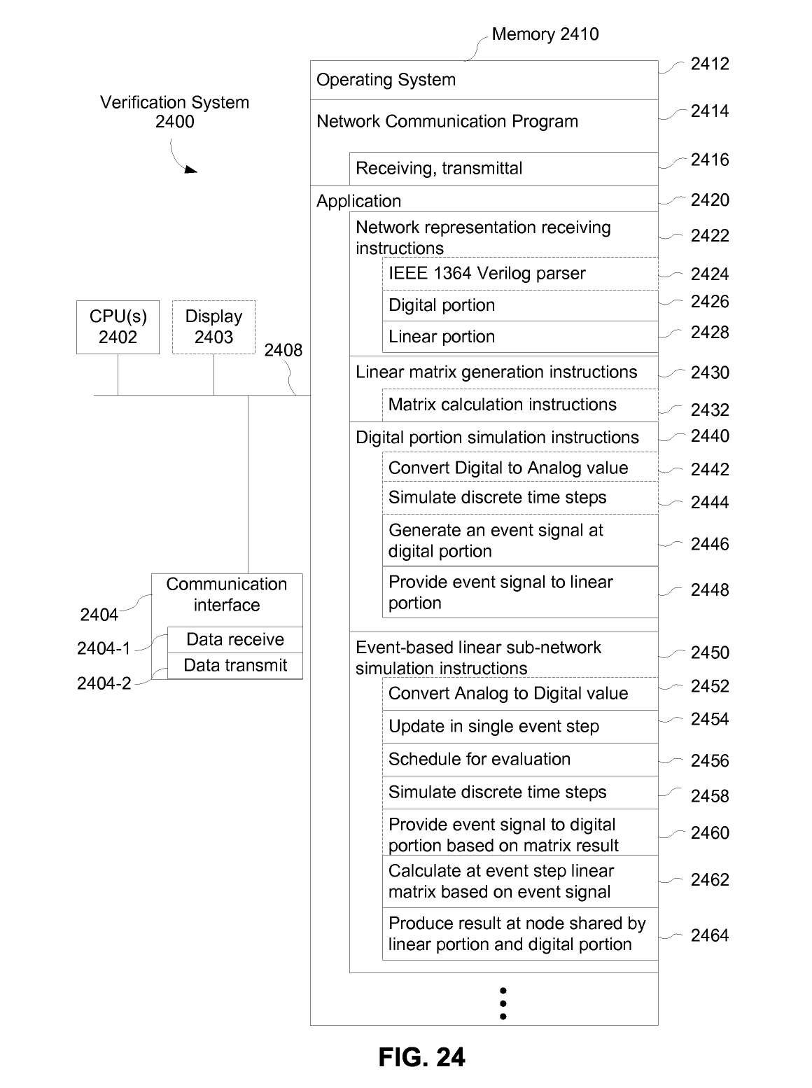

FIG. 24 is a block diagram of a verification system 2400 for simulating a circuit. Verification system 2400 includes one or more processing units (CPU's) 2402, and one or more network communication interfaces 2404 having a data receive function 2404-1 and data transmit function 2404-2. Verification system 2400 also includes memory 2410 and one or more communication buses 2408 for interconnecting these components. In an embodiment, the communication buses 2408 include circuitry (sometimes called a chipset) that interconnects and controls communications between system components. Memory 2410 includes high speed random access memory and may also include non-volatile memory such as one or more magnetic or optical disk storage devices or solid state storage devices such as Flash memory or magnetic random access memory (MRAM). Memory 2410 optionally includes one or more storage devices remotely located from the CPU(s) 2402.

In some embodiments, the system 2400 includes a display 2403 that is local to the system 2400, while in other embodiments the system includes, utilizes or sends information to a display 2403 that is located remotely from the system 2400. For example the display 2403 may be part of a workstation or other computer located across a network. Alternately, the display 2403 may be a network connected device to which system 2400 sends information.

Memory 2410, or alternately the non-volatile memory device(s) within memory 2410, comprises a computer readable storage medium. In some embodiments, memory 2410 stores the following programs, modules and data structures, or a subset or superset thereof:
an operating system 2412 that includes procedures for handling various basic system services and for performing hardware dependent tasks;
a network communications module (or instructions) 2414 that is used for connecting verification system 2400 to other computers via one or more communications network interfaces (wired or wireless) and one or more communications networks, such as the Internet, other wide area networks, metropolitan area networks, and local area networks. The network communications 2414 includes receipt and transmittal instructions 2416 for implementing the above connections.
an application 2420 having one or more procedures, programs or sets of instructions for implementing certain aspects of the verification system.

In an embodiment, the application 2420 includes network representation receiving instructions 2422 for accessing or receiving a representation of an electrical network or circuit design having a plurality of sub-networks. In an embodiment, the representation of the electrical network is in IEEE 1364 Verilog. In an embodiment, the network representation instructions 2422 optionally include a parser 2424 for parsing the IEEE 1364 Verilog representation of the electrical network. The plurality of sub-networks includes a digital portion 2426 and a linear portion 2428 that share a node.

The application 2420 also includes linear matrix generation instructions 2430 for generating a linear matrix for the linear sub network. The linear matrix generation instructions 2430 optionally include matrix calculation instructions 2432 for calculating a value of the linear matrix representing the linear sub-network.

The application 2420 also includes digital portion simulation instructions 2440 for simulating the digital portion of the network representation. The simulation instructions 2440 optionally include one or more of the following: digital-to-analog conversion (DAC) instructions 2442 to convert a digital (logic) value to an analog (linear) value, and instructions 2444 to simulate the digital portion in discrete time steps. The simulation instructions 2440 include instructions 2446 to generate an event signal at a digital portion, and instructions 2448 to provide an event signal to the linear portion.

The application 2420 also includes event-based linear sub-network simulation instructions 2450. Instructions 2450 optionally include one or more of the following: analog-to-digital conversion (ADC) instructions 2452 to convert an analog (linear) value to a digital (logic) value, instructions 2454 to update a linear sub-network simulation in a single event step, include instructions 2456 to schedule the linear sub-network for evaluation, instructions 2458 to simulate the linear sub-network in discrete time steps, and instructions 2460 to provide an event signal to the digital portion based on the matrix result. Event-based linear sub-network simulation instructions 2450 also include instructions 2462 to calculate at an event step, a linear matrix based on the event signal, and instructions 2464 to produce a node shared by linear portion and a digital portion.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 2410 may store a subset of the modules and data structures identified above. Furthermore, memory 2410 may store additional modules and data structures not described above.

Although FIG. 24 shows a system 2400, FIG. 24 is intended more as functional description of the various features which may be present in a workstation, a set of workstations, or a set of servers, than as a structural schematic of the embodiments described herein. In practice, and as recognized by those of ordinary skill in the art, items shown separately could be combined and some items could be separated. For example, some items shown separately in FIG. 24 could be implemented on single servers or workstations and single items could be implemented by one or more servers or workstations. The actual number of servers or workstations used to implement system 2400 and how features are allocated among them will vary from one implementation to another, and may depend in part on the amount of data traffic that the system must handle during peak usage periods as well as during average usage periods.

FIG. 25 shows a code listing 2500 having Verilog code 2510 for analog multiplexer 1810, and Verilog code 2520 for analog comparator 1820.

FIG. 26 shows a code listing 2600 having Verilog code 2610 for input sampler 1830, and Verilog code 2620 for sample and hold circuit 1840.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of simulating a circuit, comprising:
receiving a representation of an electrical network having a plurality of sub-networks, including a logic sub-network and a linear sub-network that share a node;
generating a linear matrix for the linear sub-network;
performing an event-based simulation of the linear sub-network, using the linear matrix, to produce a linear node value and a corresponding logic value for the shared node; and
performing an event-based simulation of the logic sub-network to produce a logic value on an output node, using the logic value for the shared node as an input to the simulation of the logic sub-network.

2. The method of claim 1, wherein the event-based simulation of the linear sub-network and the event-based simulation of the logic sub-network use identical discrete time steps.

3. The method of claim 1, wherein the shared node comprises a first node of the logic sub-network and a second node of the linear sub-network and a result register through which a linear value of the second node is associated with a logic value of the first node.

4. The method of claim 3, wherein a value of the result register is set in accordance with the linear value of the second node, and wherein the logic value of the first node is set in accordance with the value of the result register.

5. The method of claim 3, including setting the value of the result register by performing an analog to digital conversion operation on the linear value of the second node to produce a conversion result, and setting a value of the result register in accordance with the conversion result.

6. The method of claim 3, wherein the logic sub-network and linear sub-network share a second node, the second shared node comprising a third node of the logic sub-network coupled to a control input of a circuit element of the linear sub-network.

7. The method of claim 3, wherein the logic sub-network and linear sub-network share a second node, the second shared node comprising a third node of the logic sub-network and a fourth node of the linear sub-network and a control register through which a logic value of the third node is associated with a linear value of the fourth node.

8. The method of claim 7, including setting the linear value of the fourth node and setting a control value of a circuit element of the linear sub-network in accordance with the linear value of the fourth node.

9. The method of claim 7 including setting a value of the control register in accordance with the logic value of the third node, and setting the linear value of the fourth node in accordance with the value of the control register.

10. The method of claim 3, wherein simulating the linear sub-network comprises simulating a circuit element having a control parameter.

11. The method of claim 10, wherein the logic sub-network and linear sub-network share a second node, the second shared node comprising a third node of the logic sub-network coupled to the control parameter.

12. The method of claim 7, including executing an event driver coupled to the control register and an event listener coupled to the result register.

13. The method of claim 7, including monitoring the control register, and if an event is observed, scheduling the linear sub-network for evaluation.

14. The method of claim 13, including, after the scheduling, evaluating the linear sub-network by calculating the linear matrix for the linear sub-network, and updating the result register according to the linear matrix.

15. The method of claim 14, wherein the updating is performed during a single event step.

16. The method of claim 14 wherein updating the result register according to the linear matrix comprises providing linear values to the result register.

17. The method of claim 7 wherein associating a logic value of the third node with a linear value of the fourth node includes performing a digital to analog conversion operation.

18. The method of claim 1, wherein the linear sub-network comprises at least two analog circuit elements each selected from the group consisting of a variable current source, a variable resistor, a variable voltage source, a switch, a voltmeter, an ideal operational amplifier, an operational amplifier with adjustable gain, a voltage controlled voltage source, a voltage controlled current source, a current controlled voltage source, a current controlled current source, an analog multiplexer, a comparator, an input sampler, and a sample-and-hold circuit.

19. The method of claim 1, including parsing a representation of the linear sub-network that is compliant with IEEE 1364 Verilog.

20. A computer implemented method of simulating a circuit, comprising:
receiving a representation of an electrical network having a digital portion and a linear portion;
generating a linear matrix for the linear portion;
simulating operation of the digital portion, including generating an event signal at the digital portion, and providing the event signal to the linear portion; and
at an event step, calculating the linear matrix based on the event signal to produce a result at a node shared by the linear portion and digital portion.

21. The method of claim 20, wherein the simulating includes storing in a control register a value corresponding to the event signal, and the calculating includes accessing the value stored in the control register and storing a result value corresponding to the produced result in a result register.

22. The method of claim 20 further comprising providing a logic value to the digital portion based on the result at the node shared by the linear portion and digital portion.

23. The method of claim 22 wherein providing a logic value to the digital portion includes performing an analog to digital conversion operation.

24. The method of claim 20 wherein providing the event signal to the linear portion includes performing a digital to analog conversion operation.

25. The method of claim 20, including parsing a representation of the linear portion that is compliant with IEEE 1364 Verilog.

26. The method of claim 20 wherein the generating, simulating, and calculating use identical discrete time steps.

27. A computer-implemented system for performing a simulation, comprising:
one or more processors; and
memory storing one or more programs, the one or more programs including:
instructions for receiving a representation of an electrical network having a plurality of sub-networks, including a logic sub-network and a linear sub-network that share a node;
instructions for generating a linear matrix for the linear sub-network;
instructions for performing an event-based simulation of the linear sub-network, using the linear matrix, to produce a linear node value and a corresponding logic value for the shared node; and
instructions for performing an event-based simulation of the logic sub-network to produce a logic value on an output node, using the logic value for the shared node as an input to the simulation of the logic sub-network.

28. A computer-implemented system for performing a simulation, comprising:
one or more processors; and
memory storing one or more programs, the one or more programs including:
instructions for receiving a representation of an electrical network having a digital portion and a linear portion;
instructions for generating a linear matrix for the linear portion;
instructions for simulating operation of the digital portion, including generating an event signal at the digital portion, and providing the event signal to the linear portion;
instructions for calculating at an event step the linear matrix based on the event signal to produce a result at a node shared by the linear portion and digital portion.

29. A computer readable storage medium, the medium comprising instructions which when executed on a server will cause the server to:
receive a representation of an electrical network having a plurality of sub-networks, including a logic sub-network and a linear sub-network that share a node;
generate a linear matrix value for the linear sub-network;
perform an event-based simulation of the linear sub-network, using the linear matrix, to produce a linear node value and a corresponding logic value for the shared node; and
perform an event-based simulation of the logic sub-network to produce a logic value on an output node, using the logic value for the shared node as an input to the simulation of the logic sub-network.

30. A computer readable storage medium storing instructions which when executed on a server cause the server to:
receive a representation of an electrical network having a digital portion and a linear portion;
generate a linear matrix for the linear portion;
simulate operation of the digital portion, including generating an event signal at the digital portion, and providing the event signal to the linear portion; and
at an event step, calculate the linear matrix based on the event signal to produce a result at a node shared by the linear portion and digital portion.
